(19) United States
(12) Patent Application Publication
(10) Pub. No.: US 2004/0204204 A1
(43) Pub. Date: Oct. 14, 2004

(54) Visual enhancer for a phone handset

(76) Inventors: Jacob Evan Brilliant, Garden Grove, CA (US); Claudia Brilliant, Garden Grove, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/410,722

(22) Filed: Apr. 9, 2003

(51) Int. Cl. H04B 1/38

(52) U.S. Cl. 455/575.1; 455/575.6

(57) ABSTRACT

A communication apparatus includes a telephone handset providing a display panel and a set of operating keys, the operating keys providing operating indicia, the panel and keys positioned on a telephone face plate. It also includes a handset case or cover providing a case face plate; and with the telephone handset positioned within the handset case or cover, a raised magnifying element of the case face plate positioned over the display panel in position for magnifying information displayed thereon. A membrane element of the case face plate is positioned over the operating keys, and provides enlarged indicia corresponding positionally with the operating indicia of the operating keys. The membrane element flexibility enables tactile location of each of the operating keys from an outfacing surface of the membrane element.

### BACKGROUND OF THE INVENTION

### INCORPORATION BY REFERENCE

Applicant(s) hereby incorporate herein by reference, any and all U.S. patents, U.S. patent applications, and other documents and printed matter cited or referred to in this application.

1. Field of the Invention

This invention relates generally to indicia magnifiers and more particularly to such a device for use with a telephone and which is positioned over a display, and which further has a thin film membrane positioned over the corresponding keypad of the phone to provide enlarged indicia for improved visual identification of the keys.

2. Description of Related Art

The following art defines the present state of this field:

Goldberg, U.S. Des. 269,512 describes the design for a number enlarger cover for a push-button telephone.

Powell, U.S. Des. 451,094 describes the design for a jacket cover for a cellular phone.

Bolander, U.S. Pat. No. 4,012,127 describes a magnifying attachment for use on push buttons such as those on a more modern telephone and having an image magnifying element to magnify indicia imprinted or otherwise located on a button. The attachment has a depending skirt with the magnifying element secured thereto with the skirt being sized and shaped to receive the upper end of the button therein in frictional engagement for securing the magnifying element in overlying relation to the end surface of the button. The attachment also includes an upwardly extending peripheral rib to provide protection for the magnifying element and prevent an operator's finger from slipping from the attachment and contacting an adjacent button.

Sakurai, U.S. Pat. No. 4,991,935 describes a magnifying device for use with a hand-held video display apparatus or the like having a generally rectangular housing and a video display visually observable externally of the housing. The magnifying device includes a frame adapted for releasable mounting on the video display housing, and has a magnifying lens adapted to overlie the video display and effect magnification of the video display during operation when the magnifying device is mounted on the video display apparatus.

Richard et al., U.S. Pat. No. 5,818,634 describes a dual mode optical magnifier system including a plurality of multi-order diffractive optical elements having at least one reflective, refractive and conventional diffractive surface formed thereon, that in combination and is operable between a low magnification virtual image display mode and a high magnification virtual image display mode. The multi-order diffractive optical elements include a plurality of zones defined by P.times.2.pi., where P is an integer. The use of multi-order diffractive optical elements enables the elements to be very planar and compact in form so as to be incorporated into portable electronic equipment such as cellular telephones, pagers, smart card readers, computers, or the like, while enabling the desired magnification level to be achieved.

Lincoln et al., U.S. Pat. No. 6,067,459 describes a magnification system including a display mounted on a cellular phone or the like. Also included is a frame with a transparent magnifying lens mounted therein. An adhesive lining is secured to an entire bottom surface of the frame. As such, the frame may be secured about a periphery of the display such that the lens resides above the same to magnify the numbers displayed thereon.

Heikkinen et al., U.S. Pat. No. 6,073,036 describes a wireless user station, such as a cellular telephone, which is provided with a touch sensitive input device, such as a touch-sensitive display or a touchpad. A display device displays a plurality of symbols. A first location of a tactile input is detected and displayed symbols in the vicinity of the first location of the tactile input are magnified to occupy a larger display area. Subsequently, a second location of the tactile input is detected, thereby identifying a new position of the user's fingertip. After the second location on the touch sensitive screen remains constant, or after the user lifts the fingertip, the second location of the tactile input is reported and associated with the selected symbol.

Mitchell, U.S. Pat. No. 6,082,535 describes a protective covering for a communications device including a resilient water-impermeable bag, which is of one piece. The bag has a single opening through which the communications device can be inserted in the bag, and a layer of adhesive runs around the opening on the inside of the bag. The adhesive layer is covered by a non-adhesive strip which can be peeled off to expose the adhesive layer. When the bag is closed following removal of the non-adhesive strip, the adhesive layer forms a water-impermeable seal for the opening of the bag.

Ferraro, U.S. Pat. No. 6,151,172 describes a removably attached magnifying lens which is designed for placement on display windows of small devices such as are found on cellular telephones and the like. The lens is mounted onto an adjustable housing having tabs thereon for being grasped by the hands of the user whereby the display window can be brought into visual focus. The housing can be attached to the display window or to, for example, the instrument panel of an airplane by adhesive means or a strap system. Also, the present invention can be designed to fit variously shaped gauges, for example, round or square gauges.

Shaffer, U.S. Pat. No. 6,275,333 describes a magnification device for being removably mounted onto the display window of a cell phone or the like. The device discloses a housing member having a plurality of removable magnifying lenses contained therein. The lenses may be removable by being stacked onto each other or mounted in slots disposed in the housing. A strap is provided having mating hook and loop material on its ends for attachment about a cell phone or the like. An additional external hook and loop member is provided to allow attachment of the strap and cell phone to a proximate object. A removable clip may also be provided for attachment of the strap and cell phone to an article of clothing.

Ferraro, U.S. Pat. No. 6,307,686 describes a removably attached magnifying lens which is designed for placement on display windows of small devices such as are found on cellular telephones and the like. The lens is mounted onto an adjustable housing having tabs thereon for being grasped by the hand of the user whereby the display window can be brought into visual focus. The housing can be attached to the display window or to, for example, the instrument panel of an airplane by adhesive means or a strap system. Also, the present invention can be designed to fit variously shaped gauges, for example, round or square gauges.

Snyder, U.S. Pat. No. 6,389,268 describes electronic device holders, such as vehicle cradles and holsters with optical elements that are configured to overlie and magnify the display panel of an electronic device supported thereby. An elongate, adjustably bendable arm may be utilized to allow a user to maneuver an optical element to any of a plurality of positions relative to an electronic device display panel.

Inomata et al., US-2001-0024945 describes a portable telephone to which additional function units, such as a flip unit and a slide unit, that provide additional functions for the main body of a portable telephone, are easily mounted on the case of a basic unit that includes only the essential units required for speech. One or more of an LCD bezel 40, a flip cover 50, a keypad bezel 60, grips 70, a keypad slide cover 80 and a slide cover 90, which are additional function units, are mounted on a basic unit 20. Therefore, this arrangement can cope with a request from a user who desires to alter a portable telephone he or she purchased to obtain a model he or she favors.

Wang, US-2001-0051508 describes an optical magnifying device including a frame which is connected to a cellular phone and a magnifying plate connected to the frame. The frame is able to be slid or pivoted relative to the body of the cellular phone so that the magnifying plate is moved to the buttons or the screen of the cellular phone.

Mujica, US-2002-0183017 describes a combination cellular telephone and digital recorder device that is used to make and receive telephone calls, save telephone calls, and to record telephone conversations while speaking through the phone comprising of speakers in order to listen to the conversation either privately by the user or at loud for other persons to hear. It includes a resting alternate stand piece for the device to rest; ear phone jack; battery charger jack; recorder ear jack; recorder digital features; and a telescoping antenna with the option to articulate the antenna or not, that permits a better communication sound waives depending of the area; Also, includes a holder hook to carry the device; and a telephone cover that has a lip at the edge; that has the function of opening and closing to protect the device. Same telephone cover has a Window magnifier for a better view for incoming calls; and menu/folder of the telephone display. The present invention has a special loop handle preventing the device to slip through the hands; Also comprised with a luminic panel of multitude digital numbers on a vertical position design, additionally with variable letters and symbols.

Ferraro, WO 01/35153 describes a removably attached magnifying lens which is designed for placement on display windows of small devices such as are found on cellular telephones and the like. The lens is mounted onto an adjustable housing having tabs thereon for being grasped by the hands of the user whereby the display window can be brought into visual focus. The housing can be attached to the display window or to, for example, the instrument panel of an airplane by adhesive means or a strap system. Also, the present invention can be designed to fit variously shaped gauges, for example, round or square gauges.

The prior art teaches a portable phone with slide cover similar to the instant invention, and also various magnifying devices placed over displays and or buttons of the phones, but does not teach the instant combination of a magnifier for the phone's display combined with a thin film membrane with enlarged indicia for the keys. The present invention fulfills these needs and provides further related advantages as described in the following summary.

### SUMMARY OF THE INVENTION

The present invention teaches certain benefits in construction and use which give rise to the objectives described below.

A communication apparatus includes a telephone handset providing a display panel and a set of operating keys, the operating keys providing operating indicia, the panel and keys positioned on a telephone face plate. It also includes a handset case or cover providing a case face plate; and with the telephone handset positioned within the handset case or cover, a raised magnifying element of the case face plate positioned over the display panel in position for magnifying information displayed thereon. A membrane element of the case face plate is positioned over the operating keys, and provides enlarged indicia corresponding positionally with the operating indicia of the operating keys. The membrane element flexibility enables tactile location of each of the operating keys from an outfacing surface of the membrane element.

A primary objective of the present invention is to provide an apparatus and method of use of such apparatus that provides advantages not taught by the prior art.

Another objective is to provide such an invention capable of enabling improved visibility of the display of a phone.

A further objective is to provide such an invention capable of providing improved visibility of the indicia on key of a phone.

A still further objective is to provide such an invention capable of that may be enabled for use as a phone case or a cover attachment.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of a prior art phone handset;

FIG. 2 is a perspective view of a phone case according to the invention;

FIG. 3 is a perspective view of a phone cover according to the invention;

FIG. 4 is a section view taken along line 4-4 in FIG. 3;

FIG. 5 is a perspective view of the phone handset of FIG. 1 when inserted into the case of FIG. 2; and

FIG. 6 is a perspective view of the phone handset of FIG. 1 as used with the cover of FIGS. 3 and 4.

### DETAILED DESCRIPTION OF THE INVENTION

The above described drawing figures illustrate the invention in at least one of its preferred embodiments, which is further defined in detail in the following description.

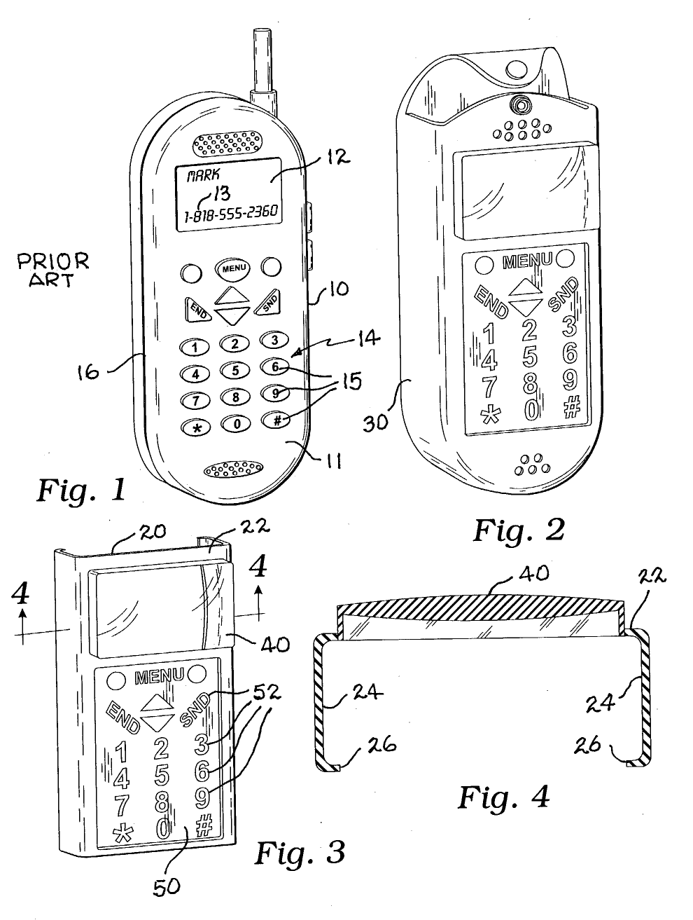

The present invention includes a communication apparatus, such as a cell phone, well known in the prior art, and illustrated in FIG. 1. The present invention further comprises as a combination, a telephone handset 10 (hereafter “phone 10”) and a cover 20, or case 30, which provides improved visibility and readability of both the phone's display panel 12 (hereafter “panel 12”), and its operating keys 14. Therefore, the phone 10 has a display panel 12 as is well known in modern phones, and a set of operating keys 14 as is necessary for operation of all telephones. The operating keys 14 are identified by operating indicia 15, usually the numerals 1 through 9, plus *, 0 and # as shown in FIG. 1. The panel 12 and keys 14 are positioned on a telephone face plate 11 of the phone 10. The present invention further includes, in one embodiment, shown in FIG. 6, a handset cover 20, as stated, providing a cover face plate 22 and a pair of cover side walls 24 which depend from the cover face plate 22. Each of the cover side walls 24 provides an inwardly directed flange ridge 26 forming a terminal distal edge. With the handset cover 20 engaged with the phone 10, a raised magnifying element 40 of the cover face plate 22 is positioned over the display panel 12 in just the correct position for magnifying the information 13 displayed on the panel 12. Further, a membrane element 50 is attached to the cover face plate 22 and is positioned over the operating keys 14. The membrane element 50 provides enlarged indicia 52 corresponding positionally with the operating indicia 15 of the operating keys 14. The membrane element 50 enables tactile locating of each of the operating keys 14 from an outfacing surface 54 of the membrane element 50.

Preferably, the panel 12 uses liquid crystal elements for displaying information including pictorial and text information 13. Because these panels 12 are usually small, the information displayed is likewise, so that a magnification of such information is necessary for many individuals to see it clearly and easily. The magnifying element 40 may be a plano-convex lens as shown in FIG. 4, or a Fresnel type lens (not shown), both of which are well known in the art.

Preferably, the flange ridges 26 of the handset cover 20 are engaged with a parting groove 16 in the phone 10.

Preferably, the membrane element 50 is made of a thin elastomeric sheet material that is tightly stretched over the operating keys 14 so that an outline of the keys may be seen on the membrane element 50, and the operating keys 14 provide tactile feedback, as is well known, so that the keys 14 must be pressed so to move, to active them, thereby allowing a finger to easily find each key 12. Note that the indicia 52 associated with each key 14 is larger on the membrane element 50 than it is on the keys 14.

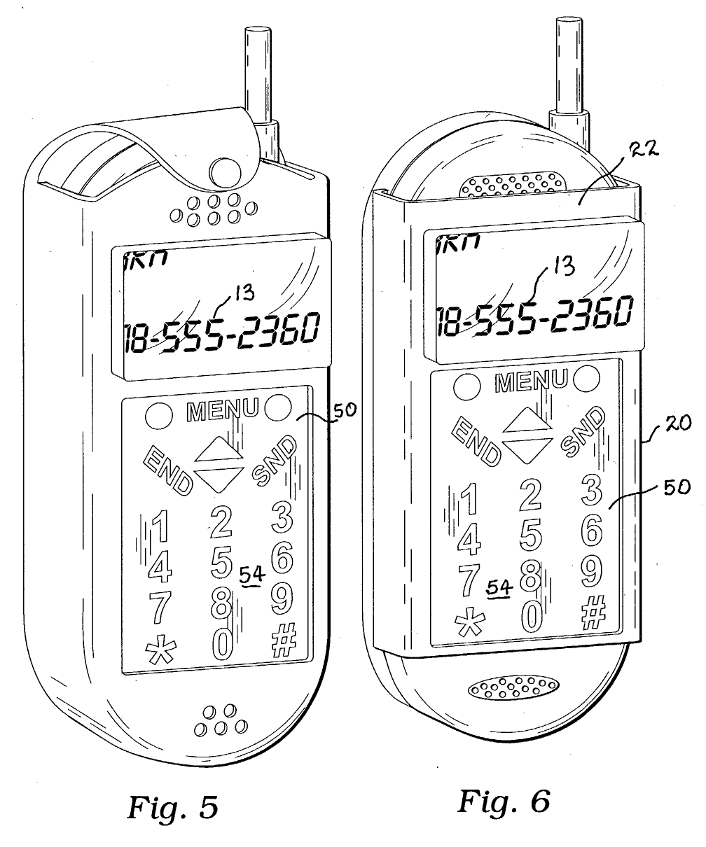

In an alternate embodiment, shown in FIG. 5, the cover is replaced by the full phone case 30 into which the magnifying element 40 and the membrane element 50 are mounted. The phone 10 is placed into the case 30 and the magnifying element 40 and the membrane element 50 are then in positional registration with the panel 12 and the keys 14 respectively, as described above.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A communication apparatus comprising in combination: a telephone handset providing a display panel and a set of operating keys, the operating keys providing operating indicia, the panel and keys positioned on a telephone face plate of the telephone handset; and a handset cover providing a cover face plate and a pair of cover side walls depending from the cover face plate, each of the cover side walls providing an inwardly directed flange ridge forming a terminal distal edge thereof; and with the handset cover engaged with the telephone handset, a raised magnifying element of the cover face plate positioned over the display panel in position for magnifying information displayed thereon, and a membrane element of the cover face plate positioned over the operating keys, the membrane element providing enlarged indicia corresponding positionally with the operating indicia of the operating keys, the membrane element flexibility enabling tactile locating of each of the operating keys from an outfacing surface of the membrane element.

2. The apparatus of claim 1 wherein the display panel uses liquid crystal elements.

3. The apparatus of claim 1 wherein the operating keys provide tactile feedback.

4. The apparatus of claim 1 wherein the flange ridge of the handset cover are engaged with a parting groove in the telephone handset.

5. The apparatus of claim 1 wherein the membrane element is made of a thin elastomeric sheet material.

6. The apparatus of claim 5 wherein the membrane element is stretched tightly over the operating keys.

7. A communication apparatus comprising in combination: a telephone handset providing a display panel and a set of operating keys, the operating keys providing operating indicia, the panel and keys positioned on a telephone face plate of the telephone handset; and a handset case providing a case face plate; and with the telephone handset positioned within the handset case, a raised magnifying element of the case face plate positioned over the display panel in position for magnifying information displayed thereon, and a membrane element of the case face plate positioned over the operating keys, the membrane element providing enlarged indicia corresponding positionally with the operating indicia of the operating keys, the membrane element flexibility enabling tactile locating of each of the operating keys from an outfacing surface of the membrane element.

8. The apparatus of claim 8 wherein the display panel uses liquid crystal elements.

9. The apparatus of claim 8 wherein the operating keys provide tactile feedback.

10. The apparatus of claim 8 wherein the membrane element is made of a thin elastomeric sheet material.

11. The apparatus of claim 10 wherein the membrane element is stretched tightly over the operating keys.
